(19) United States
(12) Patent Application Publication
(10) Pub. No.: US 2022/0184723 A1
(43) Pub. Date: Jun. 16, 2022

(54) TOOL AND METHOD FOR GENERATING A THREADED HOLE, THE TOOL HAVING CHIP DIVIDERS

(71) Applicant: EMUGE-WERK RICHARD GLIMPEL GMBH & CO. KG FABRIK FUR PRAZISIONSWERKZEUGE, Lauf a.d. Pegnitz (DE)

(72) Inventors: Christian BEER, Poxdorf (DE); Bernhard BORSCHERT, Bamberg (DE); Thomas FUNK, Lauf a.d. Pegnitz (DE); Dietmar HECHTLE, Pegnitz (DE); Manuel LEONHARD, Lauf a.d. Pegnitz (DE); Lukas PÖRNER, Kirchensittenbach (DE); Martin STEINBACH, Lauf a.d. Pegnitz (DE)

(21) Appl. No.: 17/428,235

(22) PCT Filed: Aug. 9, 2019
(86) PCT No.: PCT/EP2019/071499

§ 371 Date: Aug. 3, 2021

(30) Foreign Application Priority Data
Feb. 8, 2019 (DE) 10 2019 103 134.6

(51) Int. Cl. B23G 5/20; B23B 51/02; B23B 51/06; B23G 7/02

(52) U.S. Cl. CPC B23G 5/20; B23B 51/02; B23B 51/06; B23G 7/02; B23B 2251/085; B23G 2240/12; B23B 2251/14; B23G 2200/143; B23G 2200/148; B23G 2200/48; B23B 2251/087

(57) ABSTRACT

A tool for generating a threaded hole is rotatable in a rotational movement about a tool axis extending through the tool, and is movable in an axial forward direction axially of the tool axis. The tool comprises at least one thread generation area and at least one drilling area, which are rigidly motion-coupled to each other. The drilling area is provided for generating a core hole and is arranged axially offset to the tool axis with respect to the thread generation area. The thread generation area projects radially to the tool axis, runs along a helical line, and a predetermined winding sense of the thread to be generated, and has a working profile which corresponds to the thread profile of the thread to be generated. The drilling area has a drilling edge, and at least one chip divider is arranged on the drilling edge, interrupts the drilling edge.

The invention relates to a tool and method for generating a threaded hole.

A thread has a helical or helix thread with a constant pitch and can be produced as an internal or external thread. To generate an internal thread, a core hole (or: a core bore) is usually first produced in the workpiece, which can be a blind hole or a through hole, and then the thread is produced in the inner wall of the core hole. The core hole with the thread generated therein is also referred to as a threaded hole.

An overview of the thread generating tools and work processes in use is given in the Handbuch der Gewindetechnik and Frästechnik, published by EMUGE-FRANKEN, publisher: Publicis Corporate Publishing, year of publication: 2004 (ISBN 3-89578-232-7), hereinafter referred to only as “EMUGE Manual”.

Core hole drilling is described in the EMUGE manual, chapter 7, pages 161 to 179.

For thread generation, both cutting and non-cutting processes and thread tools are known. Thread cutting is based on material removal of the material of the workpiece in the area of the thread. Chipless (or: non-cutting) thread forming is based on the forming (or: re-shaping) of the workpiece and the generation of the thread in the workpiece by pressure.

Axially working taps (see EMUGE manual, chapter 8, pages 181 to 298) and circularly working thread milling cutters (see EMUGE manual, chapter 10, pages 325 to 372) fall under the heading of thread cutting or chip removing.

The non-cutting thread forming tools include the axial thread formers (see EMUGE manual, chapter 9, pages 299 to 324) and also the circular thread formers.

Taps and thread cutters have cutting or forming teeth arranged helically around the tool axis under the thread pitch of the thread to be produced and operate with an exclusively axial feed movement with rotational movement around their own tool axis synchronised according to the thread pitch. The direction of rotation of the tap and thread cutter when generating the thread corresponds to the direction of winding of the thread to be produced. Once the thread has been produced, the tool is braked and brought to a standstill at a reversal point. Now, in order to bring the tool back out of the workpiece, a backward or reversing movement is initiated in which the axial feed direction and the direction of rotation are exactly opposite to the working movement and the axial feed movement and rotational movement are again synchronised according to the thread pitch in order not to damage the thread.

Combination tools are now also known with which a threaded hole can be produced in the solid material of the workpiece, i.e. without drilling a core hole beforehand, in a single operation using the same tool. These combination tools comprise a drilling area at the front end to generate the core hole and an axially adjacent thread generation area to generate the thread in the core hole generated by the drilling area.

There are combination tools in which the drilling area and the thread generation area do not work simultaneously or at once, but one after the other. An example of this is the tool known as “KOMBI”, which is described in the EMUGE manual on page 221 and in which a through-threaded hole is produced in thin-walled components and sheet metal, whereby the drill tip must already have emerged from the workpiece before tapping.

Furthermore, combination tools are also known in which the drilling area and the thread generation area work simultaneously or at once. Examples are known from the publications DE 1 818 609 U1, DE 2 323 316 A1, DE 32 41 382 A1, DE 10 2005 022 503 A1 and DE 10 2016 008 478 A1.

DE 1 818 609 U1 discloses a combination tool which has at its front end a drill tip of a twist drill with two or more cutting lips tapering conically to the drill axis and immediately followed by tapping teeth. The thread cutting teeth can only run over a few, for example three, pitches of the thread. Furthermore, helical or axially parallel running chip removal grooves are provided, on which both the cutting lips of the spiral drill part and the thread cutting teeth are located. This combination tool can also be used to generate blind threaded holes.

DE 2 323 316 A1 discloses a method for drilling threded holes by means of a tap, in which an oscillating rotary stroke movement in the pitch direction of the thread is superimposed on the helical main movement of the tap, whereby tapping is carried out into the solid material in one operation.

DE 32 41 382 A1 discloses a nut tap for through holes, in which the tap is combined with the tap hole drill to form a combination tool to be used in a single operation. The chip removal grooves of the twist drill located in the front area of the combination tool can continue into the tapping area, so that the tapping teeth are also located on the chip removal grooves. In another embodiment, separate chip removal grooves can be provided in the tapping section, which can also run parallel to the axis.

From DE 10 2005 022 503 A1 various combinations of simultaneously working drilling area and thread generation area in a combination tool for generating a threaded hole are known, among others also the combination of an axially working drilling area and an axially working thread forming area in one tool.

Another combination tool is known from DE 10 2016 008 478 A1, with which a threaded hole in a workpiece is produced in one work step solely by means of an axial working movement. With this combination tool, which is known as a single-shot tapping tool, the core hole drilling and the internal thread cutting are carried out in a common tool stroke. In this well-known process, a tapping stroke is followed by a counter-rotating reversing stroke. In the tapping stroke, on the one hand the main cutting edge generates the core hole drilling and on the other hand the thread profile generates the internal thread on the inner wall of the core hole drilling until a usable nominal thread depth is reached. The tapping stroke is carried out during a tapping feed with synchronised speed of the tapping tool. In a subsequent reverse stroke, the tapping tool is guided out of the threaded hole in a reversing direction, with an opposite reversing feed and thus synchronised reversing speed. This ensures that the thread profile of the tapping tool is moved without load in the thread of the internal thread.

The tapping stroke is not immediately followed by the reversing stroke, but rather by a groove forming step or groove forming stroke, in which a circumferential groove without thread pitch is formed adjacent to the internal thread, in which the thread profile of the tapping tool can turn without load. The tapping tool is moved beyond the nominal thread depth for the tapping stroke until a nominal bore depth is reached, with a groove form feed as well as a groove form speed, which are not synchronised with each other and are different from the tapping feed and the tapping speed. In this way, the tapping speed can be reduced to 0 without tool breakage or breakage of the thread profile due to excessive cutting edge load. The circumferential groove is produced during the groove-form stroke by means of the main cutting edge and the thread cutting tooth (or general thread tooth) of the thread profile on the tapping tool. When the nominal bore depth is reached, the groove form feed is reduced to 0. At the same time, the groove form speed is also reduced to 0 in order to enable the reversal of the direction of rotation required for the reversing stroke.

At the start of the reversing stroke, the familiar tapping tool is actuated in such a way that the thread cutting tooth can be retracted into the thread run-out without load, which ends in the circumferential groove. How this is to be done, however, is not revealed in DE 10 2016 008 478 A1. The tapping tool is then guided out of the threaded hole in a reversing direction opposite to the tapping direction, with a reversing feed and thus synchronised reversing speed, whereby the thread cutting tooth can be turned out of the threaded hole without material removal.

The tapping tool according to DE 10 2016 008 478 A1 has a clamping shank and an adjoining tapping body, along the longitudinal axis of which at least one flute extends to a frontal main cutting edge at the drill tip. At its drill tip, the tool has three front-side main cutting edges evenly distributed around its circumference and a thread profile which lags in the tapping direction. A total of three circumferentially distributed flutes extend up to the respective main cutting edge on the front side at the drill tip. At each main cutting edge, a rake face limiting the chip flute and a frontal end surface of the drill tip converge. In the circumferential direction of the tool, each flute is limited by one of a total of three drill ridges. The rake face of the flute merges into an outer circumferential back surface of the respective drilling edge, forming a secondary cutting edge. The secondary cutting edge and the frontal main cutting edge converge at a radially outer main cutting edge corner.

On the outer circumferential back surface of the drill web, the thread profile can be formed with at least one thread cutting tooth. The tooth height of the cutting tooth is dimensioned in the radial direction in such a way that the cutting tooth protrudes beyond the main cutting edge in the radial direction outwards by a radial offset. If necessary, the cutting tooth can extend the main cutting edge in the radial direction outwards flush with the main cutting edge. Alternatively and/or additionally the cutting tooth, viewed in the axial direction, can be positioned behind the main cutting edge by an axial offset. The cutting teeth are offset to each other in the axial direction on the tapping tool. Their offset dimensions are coordinated with the tapping speed and the tapping feed rate in such a way that perfect thread cutting is guaranteed.

Furthermore, circularly working combination tools are also known, such as the exclusively chip-removing drill thread milling cutters (Bohrgewindefräser, BGF) (see EMUGE manual, chapter 10, page 354) and the so-called circular drill thread milling cutter (Zirkularbohrgewindefräser, ZBGF) (see EMUGE manual, chapter 10, page 355).

Pure drilling tools, in particular twist drills, for generating holes (without threads) are normally designed with continuous cutting edges running from the inside to the outside, so that shorter chips, which curl themselves in, are produced, because the cutting speeds and circumferential lengths of the removed material, which differ radially over the cutting edge, lead to deformation and curling in of the chip. These shorter chips are well suited for the process and a distinction is made between helical chips or helical chip pieces or spiral chips or spiral chip pieces or comma chips.

In rather rare applications, in particular with larger drill diameters, drilling tools are equipped with so-called chip dividers in the cutting edges, which are combined with downstream chip forming steps or chip breakers (e.g. DE 37 04 196 A1, DE 10 2009 024 256 A1 or U.S. Pat. No. 3,076,357).

The chip dividers form interruptions of the drilling edges and can be designed as grooves or recesses or also as steps on the respective drilling edge.

Such chip dividers divide the chips, which are particularly wide for large drill diameters, into narrower chips. However, significantly longer and less curled chips, the so-called band chips, are now produced. Such band chips are useless for the process, in particular because they can get jammed between the tool and the bore wall and damage can occur, even tool breakage. For this reason, state-of-the-art drilling tools with chip dividers combine the chip dividers with downstream chip forming steps or chip breakers in order to form and break the band chips immediately.

The chip shapes mentioned herein are shown in the EMUGE manual, chapter 1, page 32 and are subdivided according to their chip classes and usability.

It is now the object of the invention to specifying a tool and a method each for generating a threaded hole in a workpiece, in which loads on the tool caused by drilling chips are kept low.

Embodiments and objects suitable for solving this task according to the invention are indicated in particular in the claims directed to a tool for generating a threaded hole, in particular with the features of independent claim 1, and a method for generating a threaded hole using such a tool, in particular with the features of claim 11.

Further embodiments and further specifications in accordance with the invention result from the respective dependent claims.

The claimable combinations of features and subject-matter according to the invention are not limited to the selected version and the selected back-references of the claims. Rather, each feature of one claim category, for example a tool, can also be claimed in another claim category, for example a process. In addition, any feature in the claims, even independently of its back-references, can be claimed in any combination with one or more other feature(s) in the claims. In addition, any feature described or disclosed in the description or drawings may be claimed on its own, alone or in any combination with one or more other feature(s) described or disclosed in the claims or in the description or drawing, independently or separately from the context in which it is contained.

In an embodiment according to the invention, a tool suitable and intended for generating (or: producing) a threaded hole is rotatable in a working movement in a rotational movement with a predetermined direction of rotation about a tool axis extending through the tool and at the same time is movable in an axial forward movement in a forward direction axially of the tool axis. The (combined and axially working) tool comprises at least one drilling area and at least one thread generation area, which are rigidly motion-coupled with each other and are thus movable synchronously with each other in the working movement. The drilling area has at least one drilling edge and is intended for generating a core hole in a workpiece during the working movement of the tool. For this purpose, the drilling area is arranged axially offset to the thread generation area in relation to the tool axis and/or is arranged in an area of the tool lying further forward in the axial forward direction, in particular at a front or free end, than the thread generation area. The thread generation area runs along a helical line (or helix) with a predetermined thread pitch angle and a predetermined winding sense of the thread to be produced (i.e. right-hand or left-hand thread) and has an working profile which corresponds to the thread profile of the thread to be generated. As a result, or in other words, the thread generation area also has a dependent thread pitch defined by the pitch angle and the diameter of the thread, which corresponds to the pitch of the thread to be produced. The thread generation area is provided for generating a thread in the surface of the core hole generated by the drilling area during the working movement of the tool, wherein during the generation of the thread, the rotational movement and the axial forward movement in the working movement are synchronised so that when the tool is rotated through 360°, an axial forward movement by the thread pitch is performed. The thread generation area projects radially to the tool axis further outwards than the drilling area. This means that the thread can be produced without radial infeed of the tool and the drilling area can be moved out through the threaded hole during a reversing movement without destroying the thread.

The tool is thus a combined tool and, during the working movement of the tool, the drilling area of the tool generates a core hole in the workpiece and the thread generation area of the tool simultaneously generates a thread in the surface of this core hole under the specified thread pitch, which then results in a threaded hole (core hole with thread). This means that the drill chips produced by the drilling area during the working movement must be led past the thread produced by the thread generation area and then also be removed from the threaded hole.

In accordance with one aspect of the invention, this combined tool, which is designed in this way, has at least one chip divider on the cutting edge, which forms an interruption of the cutting edge.

According to another aspect of the invention, a method for generating a thread with a predetermined thread pitch and with a predetermined thread profile in a workpiece is provided, comprising the following steps:

a) Use of a tool according to the invention,
b) Moving the tool into the workpiece in a working movement during a first work phase,
c) wherein the working movement comprises a rotational movement with a predetermined direction of rotation about the tool axis of the tool and an axial feed movement of the tool in an axial forward direction axially to the tool axis, synchronised with the rotational movement according to the thread pitch, such that a full rotation of the tool about the tool axis corresponds to an axial feed of the tool by the predetermined thread pitch,
d) wherein during the working movement the drilling area of the tool generates a core hole in the workpiece and the thread generation area generates a thread in the inner wall of the core hole produced by the drilling area in the first working phase, the thread running under the predetermined thread pitch, the drilling area and the thread generation area executing the working movement together without changing their relative position to each other.

For combined tools according to the state of the art, e.g. according to DE 10 2016 008 478 A1, continuous drilling edges without chip dividers are provided in the drilling area. With continuous drilling edges, short and curled up drill chips (comma chips) are produced which are well suited for the process. These typically have the length of the circumferential distance or pitch angle between the successive drilling edges and curl up at different radii due to different cutting speeds and path lengths.

However, tests have surprisingly shown that these well usable smaller drill chips are nevertheless unfavourable for the process with the combined tool, in particular that the desired thread depths of 2 to 2.5 times the thread diameter could not be achieved, but that tool breakage frequently occurred. Investigations into the reasons for this have not yet been completed. However, a probable explanation for this is that the smaller drill chips may get caught and jammed in the thread produced by the thread generation area.

However, the chip dividers according to the invention now generate band chips in the drilling area, i.e. long coherent and little curled up drill chips. Such band chips are all the more useless for the process, which is well known to the person skilled in the art (see as mentioned above, EMUGE manual, chapter 1, page 32). Therefore a person skilled in the art would not consider chip dividers with this combined tool, because the person skilled in the art had to expect, based on his experience and expertise, that chip dividers and the band chips they generate would even aggravate the chip problem instead of improving it.

For the chip forming steps used in pure drilling tools according to the state of the art mentioned above for breaking the band chips produced by the chip dividers, there would be no space in the combined tool or the drilling area would have to be designed significantly longer and the corresponding drill hole depth would consequently be missing in the thread depth. In addition, there would be no guarantee at all that the broken band chips would not then get stuck in the thread.

The invention is based on the extremely surprising observation that, with the combined tool and process according to the invention, even without chip breakers or chip forming stages, practically no band chips remain or are found in or outside the threaded hole. Investigations into why this is the case have not yet been completed. From the present perspective, the inventors explain these astonishing observations as follows. The band chips produced in the drilling area due to the chip dividers probably do not settle in the thread due to their size. Rather, the band chips between the tool, in particular webs between chip removal grooves and their web edges, on the one hand, and the threaded hole wall provided with the thread, i.e. not smooth, on the other hand, are strongly deformed and thus broken. The thread thus appears to act as a kind of chip breaker for the band chips. With a smooth wall, the band chips would not be broken up.

This chip breaking process between the tool, in particular webs between chip removal grooves, and the workpiece surface with thread, generates broken band chips or band chip fragments of such a size and shape that they no longer jam between the tool and the hole wall like the unbroken band chips, but still do not jam in the thread like the drilling chips that are produced without chip dividers. This unexpected effect and surprising but pleasing finding has now led to the fact that thread depths corresponding to 2 to 2.5 times the thread diameter could be achieved without any problems with the chip dividers on the drilling edges.

In one embodiment, the drilling area has a number n of at least two drilling edges, which are arranged offset to one another in the direction of rotation, in particular by a pitch angle of 360°/n, and on each of the n drilling edges at least one chip divider is arranged and/or in which the radial diameter of the drilling area relative to the tool axis is at most of 10 mm (i.e. a size in which no chip dividers are used even in pure twist drills).

In general, the radial distances of the chip dividers from the tool axis on different drilling edges are chosen differently in such a way that in a rotational projection or in the direction of rotation around the tool axis, an interruption formed by a chip divider on a first drilling edge is followed by a cutting area or a drill part cutting edge of a second drilling edge.

The axial depth of the chip divider measured in the axial direction to the tool axis from the interruption of the cutting edge is advantageously in the range of 0.5/n to 1.1/n times, in particular 1/n times, the thread pitch of the thread generation area.

A radial width of a chip divider interruption is preferably selected from a range of 0.05 to 0.25 times the diameter of the drilling area.

In a particularly advantageous embodiment, at least one chip divider is used as a chip divider groove, which forms an interruption at the respective drilling edge.

Each drilling edge is typically arranged and/or formed on an associated drill web, whereby at least one first free area adjoining the drilling edge is formed on each drill web, in particular on an end face of the drill web. The clearance angle of the first free areas can be selected in a radially outer area between 3° to 15° or 5° to 15°, in particular 6° or 10°, and can preferably increase radially inwards, in particular up to a maximum of 40°. In particular, the first free area is cone-shaped or even.

In a preferred embodiment, at least one second free area is formed on each drilling edge, in particular on an end face of the drilling edge, which adjoins the rear side of the first free area facing away from the drilling edge, the second free area being more exposed or being arranged at a larger clearance angle than the first free area. The clearance angle of the second free area is selected in a radially outer area, preferably in a range between 15° and 40° or 20° and 40°, for example 32°. The second free area(s) can also be curved or flat.

Preferably, the tool comprises at least one and preferably at least two chip removal grooves, which start in the drilling area and continue through the thread generation area into a chip area which, viewed axially to the tool axis, directly adjoins the thread generation area on the side opposite to the drilling area. At least in the chip area, preferably along the entire chip removal grooves, webs are arranged and formed between the chip removal grooves.

The chip removal grooves and the webs between them preferably run twisted around the tool axis, in particular at a constant or variable twist angle, typically in an interval of 0° to 50°, in particular 20° to 35°, for example 30°.

On the webs, in the front area, first one drilling web of the drilling area and then the thread tooth or teeth of the thread generation area can be formed.

At the outer transition areas between the webs and the chip removal grooves, at least in the chip area, web edges are formed which are generally blunt or non-cutting and in particular follow the course of the chip removal grooves. Furthermore, preferably the radial diameter of the webs and thus of the web edges in the chip area is equal to or slightly smaller than the diameter of the drilling area and thus of the produced core hole wall, in particular between 90% and 100%, for example 99.8%, of this diameter.

In a particularly advantageous embodiment, band chips produced in the drilling area due to the chip dividers are guided through the chip removal grooves and broken between the webs, in particular the web edges, of the chip area on the one hand and the threaded hole wall provided with the thread produced by the thread generation area on the other. The broken band chips are then guided through the chip removal grooves to the outside of the threaded hole.

The axial length of the chip removal grooves is generally greater than the maximum hole depth or penetration depth of the tool, so that the chip removal grooves always extend into an area above or outside the workpiece surface and can evacuate the chips from the threaded hole.

In one embodiment, at least one chip divider groove of the respective chip divider extends from the respective drilling edge into an adjacent free area or sequence of free areas.

The extension of the chip groove(s) preferably follows an essentially linear course or a sequence of at least two or three linear groove sections inclined to each other, in particular inwardly (or convexly) towards the tool axis. The linear extension of the chip groove or its sections can be tangential to a circle around the tool axis.

In addition, the extension of the chip groove(s) can be curved at least in sections, preferably convex to the tool axis.

The chip divider groove can extend in one embodiment form from the respective drilling edge into the first free area(s) behind it and usually also into the second free area(s), whereby a length of the extension of the chip divider groove can be adjusted in particular by the clearance angle(s) of the free area(s).

Furthermore, in some embodiments the chip groove can extend to an outlet for coolant and/or lubricant in the associated drill web.

The chip divider groove can also extend on the chip area of the respective drilling edge in a different embodiment.

At least one chip divider or chip divider groove may have a cross-section in the shape of a triangle or trapezoid or dovetail or rectangle or double wave or rounding, in particular a semicircle, possibly with extended linear side walls.

At least one chip divider can also be designed as a chip divider step.

In all embodiments, the rake face on each cutting edge is preferably not provided with a protruding chip forming surface or chip forming step, but runs in particular steadily with a comparatively low curvature. This allows the drilling area to be more compact and axially shorter. This means, however, that the band chips are not already broken in the drilling area.

In an embodiment, the thread generation area has at least one thread tooth or a number n of at least two thread teeth, which are preferably arranged at an axial distance of P/n from each other and are preferably distributed over the circumference at pitch angles, in particular equal pitch angles 360°/n.

The thread tooth profile of at least one thread tooth can be an intermediate or preliminary profile, e.g. a lead or chamfer profile, which overlaps in particular with other thread tooth profiles of further thread teeth to form an overall profile.

Preferably at least one thread tooth has at least one thread cutting edge and optionally also a thread groove surface downstream of the thread cutting edge for generating a surface with good surface quality, wherein the active profiles of the thread cutting edge and the thread groove surface overlap to form the thread tooth profile, preferably corresponding to the thread profile, at the front area.

In a further embodiment, the thread-generating area has at least one (further) thread tooth which, in a area at the front, as seen in the direction of winding, has a thread tooth element with a thread tooth profile as an active profile for generating or finishing the thread and, in a area at the rear, as seen in the direction of winding, has a clearing element for clearing the thread produced from penetrated chips, in particular the band chip fragments, during a reversing movement. This thread tooth with clearing element is preferably the last tooth of the thread generation area, seen in the direction of the turn, and thus the first tooth in the reversing movement.

The clearing element has a clearing profile as an active profile, which preferably corresponds to the thread profile of the thread produced and/or corresponds to the thread tooth profile on its front side.

The clearing element preferably has a clearing cutting edge which has a clearing profile which corresponds to the thread tooth profile of the thread tooth element, in particular it has the same or at least on clearing profile free areas of the clearing profile the same active profile as the thread tooth profile.

In addition, the clearing element in an advantageous embodiment has a furrowed clearing surface, which is arranged downstream of the clearing blade in the opposite direction to the direction of rotation, whereby the active profiles of the clearing blade and the clearing surface overlap to form the entire clearing profile of the clearing element. The clearing surface preferably rises radially outwards, as seen in the direction of the windings, and can merge into a toothed web, which in particular has a constant profile or no free areas, whereby in particular one clearing profile head of the clearing surface and/or the toothed web is smaller than a clearing profile head of the clearing blade.

In an embodiment, the process includes the further process step:

movement of the tool in a deceleration movement following the working movement during a second working phase further into the workpiece in the same forward direction as the working movement up to a reversal point.

In an embodiment, a reversing movement of the tool is initiated after the reversal point has been reached, with which the tool is moved out of the workpiece, whereby the reversing movement first comprises a first reversing phase, during which the thread generation area of the tool is guided back into the thread of the generated thread, and then a second reversing phase, during which the thread generation area is guided out of the workpiece through the thread.

In an embodiment, the axial feed of the tool in relation to a full revolution is now smaller than the thread pitch, at least during part of the deceleration movement, and zero at the reversal point. The thread tooth or thread teeth thus generates or generate at least one, in particular closed or annular, circular or circumferential groove or undercut in the workpiece during the deceleration movement in the second working phase. The deceleration movement preferably comprises a rotary movement with the same direction of rotation as the working movement.

In a preferred embodiment, during the deceleration movement, the axial feed movement is controlled as a function of the angle of rotation of the tool according to a pre-stored unique relationship, in particular a function or sequence of functions, between the axial feed of the tool and the angle of rotation.

As a rule, the deceleration process or the second working phase starts at an axial feed corresponding to the thread pitch of the first working phase. The deceleration process is to be understood as deceleration from the initial thread pitch to zero at the end or at a reversal point and does not have to involve a reduction of the axial feed depending on the angle of rotation (deceleration acceleration; or braking acceleration) over the entire rotation angle interval, in particular to values below the thread pitch. Rather, rotation angle intervals are also possible in which the axial feed relative to the rotation angle is zero or is even temporarily negative, i.e. reverses its direction.

A function that defines the relationship between axial feed (or: axial penetration depth) and the angle of rotation can have a continuous range of definition and values or a discrete range of definition and values with discrete pre-stored or pre-determined pairs of values or tables of values.

In one version, the speed of rotation is also zero at the reversal point.

In one embodiment, the total or accumulated axial feed of the tool during the deceleration movement is selected or set between 0.1 to 2 times the thread pitch.

In a preferred embodiment, different relationships, in particular functions, between the axial feed of the tool and the angle of rotation are selected or set during the deceleration movement in several successive deceleration steps.

In a particularly advantageous embodiment, the axial penetration depth or the axial feed is a linear function of the angle of rotation during several, and in particular all, deceleration steps and/or in the case of the pitch, i.e. the derivative of the axial penetration depth or the axial feed according to the angle of rotation, is constant in each of these deceleration steps and decreases in terms of amount from one deceleration step to a subsequent deceleration step. This embodiment can be implemented very easily by using an NC control for a threading process, for example a G33 path condition with the thread pitch of the thread for the working movement and also using one, preferably the same, NC control for a threading process, for example a G33 path condition with the respective constant pitch as thread pitch parameter in the several deceleration steps.

In an embodiment, a reversing movement of the tool is initiated after the reversal point has been reached, with which the tool is moved out of the workpiece, whereby the reversing movement first comprises a first reversing phase, with which the thread generation area of the tool is guided back into the thread of the generated thread, and then a second reversing phase, during which the thread generation area is guided out of the workpiece through the thread.

In an advantageous embodiment, the reversing movement in the first reversing phase is controlled with the same amount (or: value) of the previously stored unambiguous relationship, inverted only in the direction of rotation and feed direction, in particular a function or a sequence of functions, between the axial feed of the tool and the angle of rotation as in the deceleration movement during the second working phase, if necessary omitting or shortening the equalisation step, if any.

The invention is further explained below by means of exemplary embodiment. Reference is also made to the drawings in which

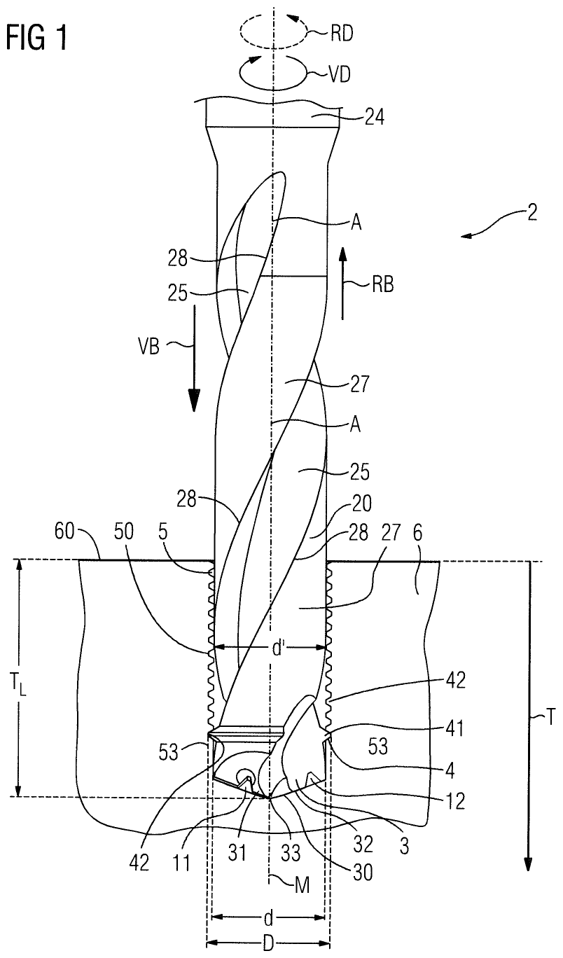

FIG. 1a shows a combined drilling and thread generating tool while generating a threaded hole,

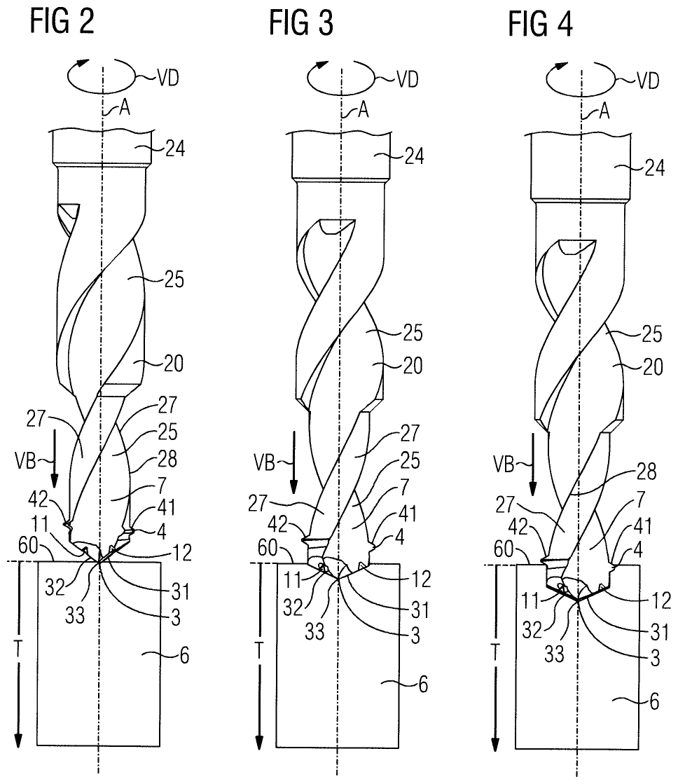

FIGS. 2 to 10 show the generation of a threaded hole with a combined drilling and thread generating tool in successive process phases,

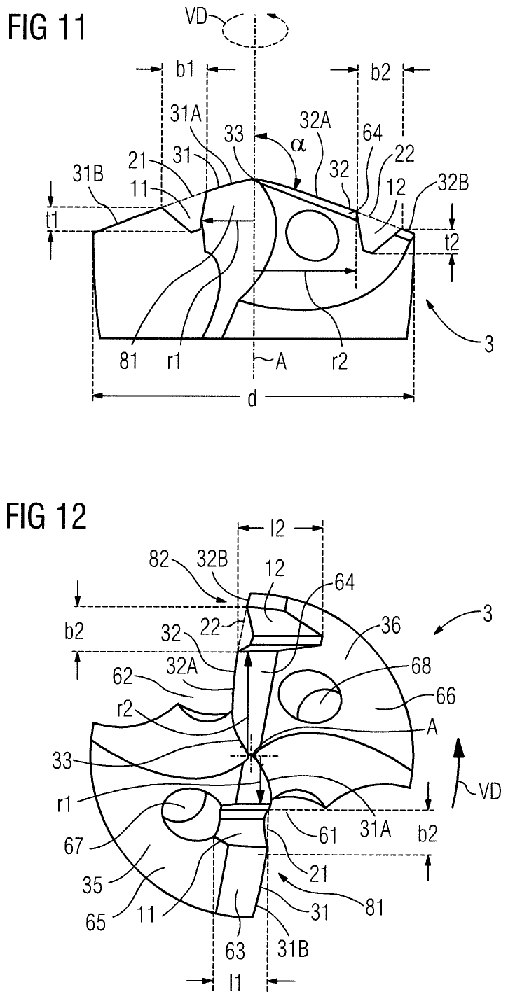

FIGS. 11 to 27 show different embodiments of a drilling area of a combined drilling and thread generating tool for the generation of a threaded hole, wherein each are shown schematically. Parts and sizes corresponding to each other are marked with the same reference signs in FIGS. 1 to 27.

First exemplary embodiments of the tool and process according to the invention are explained below using FIGS. 1 to 10.

A tool 2 is used to generate a threaded hole 5 in a workpiece 6. Tool 2 is a combination tool and generates both the core hole in the workpiece with the specified core hole diameter of the thread (in the solid material or in an already prefabricated, for example predrilled, or in a pre-drilled hole produced during the primary forming process such as casting or 3D printing) and the internal thread in the core hole, i.e. a thread turn 50 of an internal thread in the jacket wall or inner wall of the core hole. For this purpose, the tool is moved into the workpiece 6 in a working movement (or: a working stroke or thread generation movement), which is composed of a rotational movement around the tool axis on the one hand and an axial feed movement along the tool axis on the other hand.

Tool 2 is on the one hand rotatable or rotationally movable around a tool axis A running through tool 2 and on the other hand axially or translationally movable along or axially to tool axis A. These two movements are coordinated or synchronised, preferably by a control unit, in particular a machine control or NC control, while tool 2 penetrates a surface 60 of workpiece 6 and up to a hole depth TL into workpiece 6. The tool axis A remains stationary or in a constant position relative to the workpiece 6 during the generation of the threaded hole 5. The thread centre axis M of the threaded hole 5 is coaxial with the tool axis A or coincides with it during the process. The axial penetration depth (or: the axial feed) in the direction of the tool axis A measured from the workpiece surface 60 is designated T.

Tool 2 can preferably be driven by means of a coupling area on a tool shank 24 running or formed axially to the tool axis A by means of a rotary drive not shown, in particular a machine tool and/or drive or machine tool spindle, rotationally or in a rotary movement about its tool axis A in a forward direction of rotation VD and in an opposite reverse direction of rotation RD. Furthermore, tool 2 is axially movable in an axial forward movement VB or an opposite axial backward movement RB axially to the tool axis A, in particular by means of an axial drive, which in turn may be provided in the machine tool and/or drive or machine tool spindle.

A working area 20 is provided at a free end area of tool 2 facing away from the coupling area of shank 21. The working area 20 comprises a drilling area 3 at the front end of the tool 2 and a thread generation area 4 axially offset with respect to the tool axis A to the rear of the drilling area 3 or to the shank 24 as well as preferably also chip removal grooves 25.

In the exemplary embodiments shown, the chip removal grooves 25 start in the drilling area 3 and continue through the thread generation area 4 into a cutting area 7, which, seen axially to the tool axis A, directly adjoins the thread generation area 4 on the side opposite to the drilling area 3. Between the chip removal grooves 25 webs (or: backs; or: ridges) 27 are arranged and formed, on which in the front area firstly drill webs of the drilling area 3 and then thread teeth or thread webs of the thread generation area 4 are formed. However, the individual areas such as the webs 27 and the chip removal grooves 25 and the drilling area 3 and the thread generation area 4 need not be integrated in this way, but can also be formed separately.

Preferably, the chip removal grooves 25 and the webs 27 in between run twisted around the tool axis A under a constant or variable twist angle, which typically lies in an interval of 0° to 50°, in particular 20° to 35°, for example 30°, but can also run parallel or axially to the tool axis A. The axial length of the chip removal grooves 25 is selected to be greater than the maximum hole depth or penetration depth Tₘₐₓ of tool 2, i.e. in FIGS. 1 to 10 the chip removal grooves 25 always extend into an area above or outside the workpiece surface 60, in particular to a certain distance from the shank 24. In this way, at every stage of the process, the chips produced can be led out of the hole produced in the workpiece through the chip removal grooves 25.

In the exemplary embodiments shown, drilling area 3 includes frontal drill (main) cutting edges 31 and 32, which can be arranged in particular obliquely or conically, running axially forwards and can run towards or in a drill tip 33, in particular in a cone tapering towards the drill tip 33. These frontal drilling edges 31 and 32 are designed to cut in the forward direction of rotation VD, in the embodiment example shown they are right-cutting and remove material of the workpiece 6, which is axially in front of tool 2, during the forward movement VB with simultaneous rotation in the forward direction of rotation VD.

The drilling area 3 thus has an outer diameter or drill diameter d and generates a hole or core hole with this inner diameter d in the workpiece 6. The drilling edges 31 and 32 can also be called core hole cutting edges, as they generate the core hole of the threaded hole 5. The outermost dimension of the drill or core hole cutting edges 31 and 32, radial to the tool axis A, determines the core hole inner diameter d.

Drilling area 3 has two drill (main) cutting edges 31 and 32 in the exemplary embodiments shown in FIGS. 1 to 25. However, one or more than two, e.g. three or four, drilling edges may also be provided.

Located axially behind the drilling area 3 or the drilling edges 31 and 32 or axially offset in the opposite direction to the axial forward movement VB, the tool 2 comprises a thread generation area 4, which runs or is formed along a helix (or: helix, thread pitch), the pitch of which corresponds to the thread pitch P and the winding sense of which corresponds to the winding sense of the internal thread or thread turn 50 to be generated. In this sense, the helix is to be understood technically and not as a purely mathematical one-dimensional line. It also has a certain extension at right angles to the mathematical line, which corresponds to the corresponding dimension of the thread generation area 4.

The thread generation area 4 is motion-coupled with the drilling area 3 and thus the drilling area 3 and the thread generation area 4 move synchronously to each other and thus also in the working movement, which is composed of the axial movement VB or RB and the rotary movement VD or RD.

The winding sense of the thread generation area 4 as right-hand thread (or left-hand thread) corresponds to the winding sense resulting from the superposition of axial forward movement VB and forward rotary movement VD.

The thread generation area 4 generally projects further outwards radially to the tool axis A or has a greater radial outer distance to the tool axis A than the drilling area 3 or has a greater outer diameter D than the outer diameter d of the drilling area 3.

The thread generation area 4 comprises one or more, i.e. a number n greater than or equal to 1, thread teeth which are cutting and/or forming. Each thread tooth is formed or aligned or arranged along the helix. Each thread tooth has a thread tooth profile as an active profile, which is generally the outermost dimension or external profile of the thread tooth in a projection along the helix and which is formed or reflected in the workpiece during the thread forming movement, whether by cutting or by shaping or indenting.

If several (n>1) thread teeth are included in the thread generation area 4, these thread teeth are at least approximately offset from each other along the helical line (or in the axial direction). Such an arrangement along the helical line also includes embodiments in which the thread teeth are slightly laterally offset from an ideal line, for example in order to realise thread profiles with different machining on the thread free areas or a different division or superposition of the thread profiles on or to the overall thread profile. With regard to this arrangement of the thread teeth, it is only important that their arrangement is reflected in the working movement on a thread turn 50 in workpiece 6 with the same thread pitch P.

In the exemplary embodiments shown, two thread teeth 41 and 42 are provided, which are axially offset to each other, for example by half a thread pitch P/2, i.e. they are offset in the angular direction by half a turn or by 180°. However, it is also possible to have only one thread tooth or a number n>2, i.e. more than two thread teeth, which can in particular be offset to each other axially by P/n and circumferentially by 360°/n.

The thread teeth, in particular 41 and 42, project radially outwards from the tool axis A further than the drilling edges 31 and 32. The outside diameter D of the thread generation area 4 corresponds to the diameter of the generated thread turn 50 and thus of the threaded hole 5. The radial difference between the outermost dimension of the thread generating teeth and the outermost radial dimension of the core hole cutting edges corresponds in particular to the profile depth of the thread profile of the internal thread to be produced or, in other words, the difference between the radius D/2 of the thread root and the radius of the core hole d/2.

The thread profile of the internal thread, i.e. the cross-section through the thread turn 50, is produced by the thread profile composed of or superimposed by the individual active profiles of the thread teeth, e.g. 40 and 41, when the thread passes completely through the workpiece.

At the outer transition areas between the webs 27 and the chip removal grooves 25, web edges 28 are formed, at least in the chip area 7 directly adjoining the thread generation area 4, which are generally blunt or non-cutting and in particular follow the course of the chip removal grooves 25.

The diameter d′ of the webs 27 and thus of the web edges 28 arranged on the outside of the webs 27 in the chip area 7 is slightly smaller than the diameter d of the drilling area 3 and thus of the generated bore or core hole wall, for example between 90% and 98% of d, on the one hand to prevent chips from the chip removal grooves from entering the space between the webs 27 and the core hole wall, on the other hand to prevent chips from entering the space between the web edges 28 or and the threaded hole wall provided with thread 5, on the other hand to break (or: divide) long chips, in particular band chips, which are produced during the process, as will be explained later.

First of all, the process will be explained in more detail.

During a first working phase of the working movement (or: thread generation phase), tool 2 is used to generate the core hole by means of the drilling area 3 and immediately axially behind it and at least partially at the same time the thread turn 50 is generated in the core hole wall by means of the thread generation area 4. In this first working phase, the axial feed rate v along the tool axis A is adjusted and synchronised with the rotational speed for the rotary movement around the tool axis A in such a way that for one full revolution the axial feed corresponds to the thread pitch P.

In the FIGS. 2 to 6, tool 2 moves in the working movement of the first working phase in the axial forward movement VB and at the same time in a rotary movement in the forward direction of rotation VD.

As shown in FIG. 2, tool 2 with its drill tip 33 is first placed on the workpiece surface 60 and the drilling process is started (so-called spot drilling).

In FIG. 3, the drilling edges 31 and 32 have already penetrated into workpiece 6 and generate an upper area of the core hole, but the thread generation area 4 is still outside the workpiece 2.

In FIG. 4, the drilling edges 31 and 32 continue to cut the core hole and at the same time (or: synchronously) the thread generation area 4 now joins the process and begins to generate the thread here first with thread tooth 41 and shortly afterwards with thread tooth 42 in the core hole wall of the core hole already previously generated by drilling area 3.

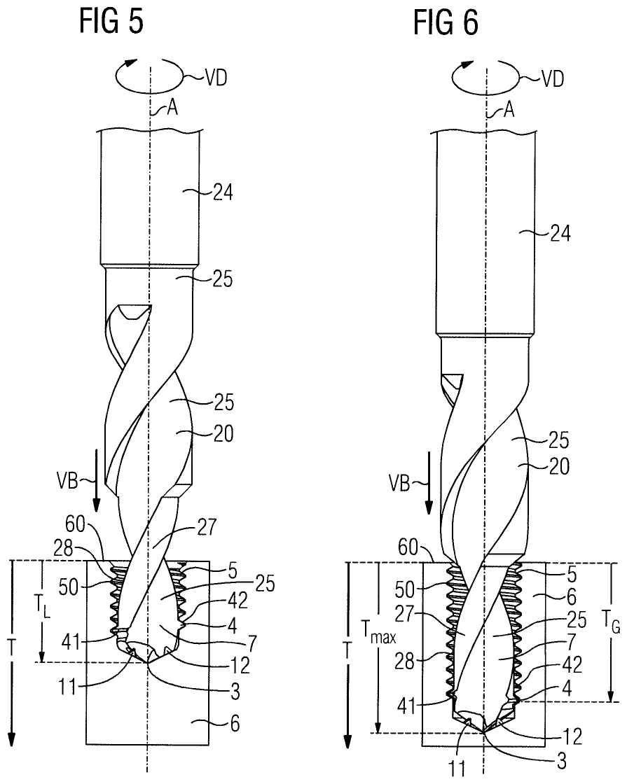

In FIG. 5, this thread generation process is already more advanced and a threaded hole 5 of hole depth TL has already been produced and a thread turn 50 of thread generation area 4 has been produced.

Now, in a second working phase immediately following the first working phase, tool 2 is braked in a deceleration process (or: in a deceleration movement) in a rotation angle interval in such a way that the axial feed V at a rotation angle of 360°, i.e. at one full revolution, of tool 2 is smaller than the thread pitch P and decreases to zero. As a rule, the deceleration process or the second working phase starts at an axial feed related to a rotation angle of 360°, which corresponds to the thread pitch P of the first working phase, i.e. V=P, and then reduces the axial feed per 360° rotation angle to values below the thread pitch P, i.e. V<P. The deceleration process is to be understood as deceleration from the initial thread pitch V=P to zero at the end or at a reversal point, i.e. V=0, and does not have to involve a reduction of the axial feed V depending on the angle of rotation (deceleration acceleration) over the entire rotation angle interval. Rather, rotation angle intervals are also possible in which the axial feed is zero in relation to the rotation angle or is even temporarily negative, i.e. reverses its direction.

In a preferred embodiment this deceleration process is carried out in defined partial steps.

This deceleration movement in the second work phase leads to the fact that the thread generation area 4 now—in what is actually an atypical or non-functional way—generates at least a circular groove or circumferential groove or undercut in the core hole wall. The shape and number of circumferential grooves depends on the number and formation and distribution of the thread teeth. The process in the second work phase can therefore be described not only as a deceleration process but also as circular groove or circumferential groove or undercut generation movement, or in the case of a purely cutting tool also as a free cutting movement.

It would also be possible to carry out the undercut or deceleration movement, for example by suitable selection of the movement parameters or also by additional axial levelling movements, in such a way that the outer width on the thread profile, in particular the free areas, are no longer visible in the circumferential groove or disappear and/or the circumferential groove only has a cylindrical shape. This could improve or enable the screwability of the generated workpiece thread.

FIG. 6 shows the transition from the first working phase, in which the maximum thread depth T_{G} is reached, to the second working phase.

The total depth or hole depth or total axial dimension of the threaded hole 5 after the second working phase is designated Tₘₐₓ.

When the total depth or maximum threaded hole depth Tₘₐₓ of threaded hole 5 is reached, tool 2 stops and reaches a reversal point.

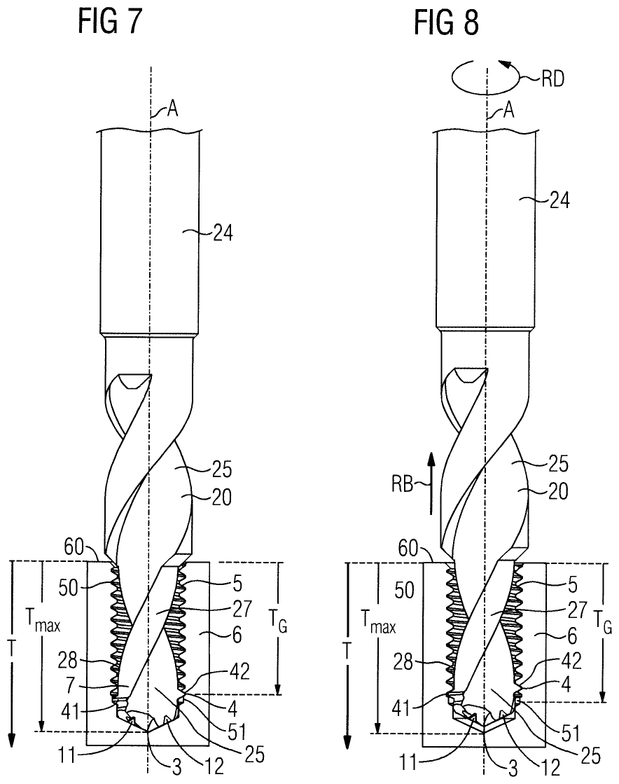

In FIG. 7 this position is shown at the reversal point. One can see the circular groove 51, which was generated during the second working phase, for example, composed of two partial grooves.

A reversing or backward movement is now immediately initiated at the reversal point. The reversing or backward movement comprises an axial backward movement RB, which is directed in the opposite direction to the forward movement VB and a rotational movement in a backward direction of rotation RD, which is opposite to the forward direction of rotation, recognisable by the reversed arrow directions.

First of all, tool 2 is moved back through the circumferential groove(s) 51 to thread turn 50 in a first reversing phase, which is shown for example in FIG. 8.

Then, in a second reversing phase, tool 2 is moved or unthreaded outwards through the thread or thread turn 50 out of the threaded hole 5 and then the workpiece 6. Due to the smaller diameter d, the thread is not damaged by the drilling area 3 even during the reversing movement.

In the second reversing phase of the reverse movement RB, the axial feed and the rotary movement of tool 2 are again synchronised with each other according to the thread pitch P in order not to damage the thread.

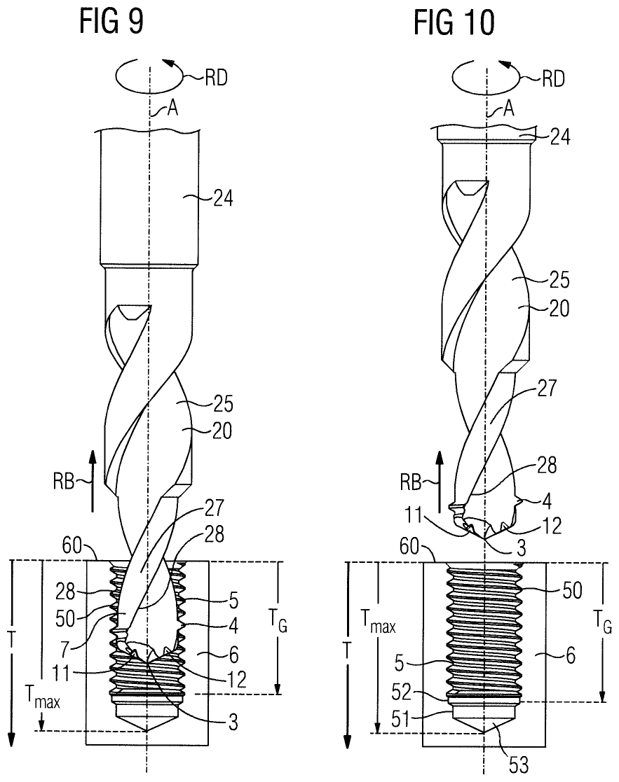

A snapshot during the second reversing phase is shown in FIG. 9.

In FIG. 10, tool 2 has already completely left threaded hole 5. The threaded hole 5 is completely visible with its thread turn 50 of thread depth T_{G}, the axially downwardly adjoining circumferential groove 51 and the further axially adjoining residual hole 53, which is only produced by the drill tip 33. The total maximum thread hole depth Tₘₐₓ of the threaded hole 5 consists of the axial dimensions of the thread turn 50, i.e. the thread depth T_{G}, and the circumferential groove 51 and the residual drill hole 53.

The thread axis or central axis of the thread with thread turn 50 is marked M and coincides with or is coaxial with tool axis A of tool 2 during the whole working movement, i.e. both in the first working phase and in the second working phase, and also during the reversing movement, i.e. both in the first reversing phase and in the second reversing phase.

Embodiments of the drilling area 3 are explained in the following with reference to further exemplary embodiments and FIGS. 11 to 27.

A first cutting edge 31 is formed on a first drill web 35 and a second cutting edge 32 on a second drill web 36.

A first chip removal groove 61 runs between the drill webs 35 and 36, seen in the forward direction of rotation VD, and a second chip removal groove 62 runs between the drill web 36 and the first drill web 35, again seen in the forward direction of rotation VD. The first drilling edge 31 is located on the first chip removal groove 61 and the second drilling edge 32 on the second chip removal groove 62.

The transition between the drilling edge 31 or 32 and the corresponding chip removal groove 61 or 62 forms a rake face (81 and 82 in FIGS. 11 and 12) on the drilling edge 31 or 32. The rake angles of these rake faces (81 and 82) on the drilling edges 31 and 32 are preferably selected in a range between −10° and +45°, whereby the rake angles preferably increase from the inside to the outside in relation to the tool axis, and can lie closer to the tool axis in a range between −10° and +10° and in the outer range lie in particular between 15° and 45°, preferably corresponding to the helix angle of the twisted chip removal grooves.

On the rear side of the drilling edge 31 or 32, which is turned away from the rake face or the associated chip removal groove 61 or 62, a first free area 63 or 64 is attached to the front face of the associated drill web 35 or 36. The rear side of the first free area 63 or 64 facing away from the drilling edge 31 or 32 is immediately followed by a second free areas 65 or 66, which is more strongly exposed than the first free area 63 or 64 or is arranged at a larger clearance angle, and which in particular essentially forms the remaining front face of the associated drill web 35 or 36 not already covered by the first free area 63 or 64.

The clearance angles of the first free areas 63 and 64 and the second free areas 65 and 66, i.e. the angles between the free area and a transverse plane running tangentially through the drilling edge perpendicular to the tool axis A, are generally selected so that, despite the high axial feed in accordance with the thread pitch P, friction of the end faces of the drill webs 35 and 36 formed by these free areas on workpiece 6 is avoided. The minimum clearance angle at a certain radius r can be calculated approximately according to the formula arctan ((axial feed per revolution/(2r π)), in this case arctan (P/(4r π)), i.e. it increases from the outside to the inside. As a rule, however, a larger clearance angle is selected to reliably prevent friction.

The clearance angle of the first free areas 63 and 64 directly adjacent to the drilling edges 31 and 32 is preferably selected between 5° to 15°, in particular 10°, in a radially outer area and increases radially inwards, in particular up to a −90°, corresponding to the roof angle of the drill tip 33. This ensures a stable drilling edge 31 or 32. The first free area 63 and 64 can be particularly cone-shaped or ground by cone-shaped grinding or can also be flat.

The clearance angle of the second free areas 65 and 66, on the other hand, is larger than that of the first free areas 63 and 64 and is preferably selected in a range between 20° and 40°, for example 32°. The second free areas 65 and 66 can also be generated with a curvature or even.

However, instead of the differently exposed free areas 63 and 65 or 64 and 66, a uniform free area with a correspondingly continuously variable clearance angle can also be provided.

In every second free area 65 and 66, an outlet 67 and 68 of a fluid channel, running through the drill web 35 and 36 respectively, discharges, for the supply of coolant and/or lubricant, which can run axially or also twisted.

The chip removal grooves 61 and 62 of the drilling area 3 preferably merge into (or: form the front area) of one chip removal groove 25 each and are preferably twisted as well. Correspondingly, the drill webs 35 and 36 preferably merge into (or:

form the front area) one web 27 each, preferably over one web of the thread generation area 4.

The drilling edges 31 and 32 are generally at least largely linear, but can also have a slightly curved, in particular in the forward direction of rotation VD convex, course at least in part. Preferably, the drilling edges 31 and 32 run at least partially parallel to each other.

The two drilling edges 31 and 32 of the shown drilling area 3 are located in particular on opposite sides of an axially running centre plane containing the tool axis A, i.e. slightly offset from the centre plane. The two drilling edges 31 and 32, for example, are arranged and designed essentially rotationally symmetrical about an angle of rotation of 180° or point-symmetrical to tool axis A.

The drilling edges 31 and 32 can run towards each other in the form of cross cuts towards the drill tip 33, which is located at the central tool axis A. In the centre or in the area of the cross-cutting edges, the rake angle and clearance angle approach each other. An angle of inclination a of the two drilling edges 31 and 32 to the tool axis A is preferably the same and can, for example, be between 90° and 135°, in particular 120°.

The tool is now equipped with chip dividers on the drilling edges, which break up the chips produced by the drilling edges and thus make them narrower. Surprisingly, this makes it possible to reduce the loads on the drilling edges that occur at the tool and during the process, in particular during the deceleration process during the second work phase, to such an extent that no tool breakage occurs. In addition, greater drilling depths can be achieved.

A first chip divider 11 is now arranged at the first drilling edge 31, in particular in the FIGS. 11 to 21, and a second chip divider 12 at the second drilling edge 32.

Each chip divider 11 or 12 forms a—dashed shown—interruption 21 or 22 of the respective drilling edge 31 or 32 and thus divides or separates these drilling edges 31 and 32 into an inner drill part cutting edge 31A in the inner area towards tool axis A and an outer drill part cutting edge 31B in the outer area away from tool axis A.

The radial distance r1 of the first chip divider 11 from the tool axis A is different, in the example of the figures smaller, selected than the radial distance r2 of the second chip divider 12. The radial distances r1 and r2 are preferably selected in such a way that there is no overlap between the chip dividers 11 and 12 in a rotary projection, i.e. they are still slightly spaced from each other. This means that the chips are divided differently and scoring at the bottom of the hole is avoided.

A radial width b1 of interruption 21 of chip divider 11 and a radial width b2 of interruption 22 of chip divider 12 are preferably chosen to be equal and/or preferably such that r1+b1<r2, thus avoiding radial overlapping of interruptions 21 and 22.

Preferred values are for the radial widths b1 and b2 a range of 0.05 d to 0.25 d and for the radial distance r1 a range of 0.05 d to 0.25 d and for the radial distance r2 a range of 0.25 d to 0.4 d.

In the FIGS. 11 to 21, the chip dividers 11 and 12 are designed as chip divider grooves, which extend at the front side of the drill webs 35 and 36 from the respective drilling edge 31 or 32 into the free area(s) 63 or 64 behind them and usually also into the free areas 65 and 66.

The lengths of the chip divider grooves or chip dividers 11 and 12 are designated 11 and 12 respectively and can be selected equal to each other and/or variable, in particular by varying the clearance angles or position of the free areas.

For a given depth t1 or t2, the length l1 or l2 of the chip divider grooves of chip dividers 11 and 12 can be adjusted, in particular, by how the free area 65 or 66 is inclined, i.e. which clearance angle is selected. With steeper orientation or larger clearance angles the length of the chip grooves is shorter and with smaller clearance angles or less steep orientation of the free areas the length of the chip grooves is greater. The free areas 65 and 66 and their comparatively large clearance angles ensure that the rear edges of the chip grooves do not rub against the workpiece.

The length or extension of the chip dividers or chip divider grooves is preferably selected so that they extend as close as possible to the outlet for the coolant and/or lubricant, in particular the outlets 67 and 68 in the drill webs 35 and 36 respectively. This allows coolant and/or lubricant to be fed through the chip divider grooves to the cutting edge.

Depending on the radial distance r1 and r2 of the chip divider grooves of the chip dividers 11 and 12 on the one hand and the radial distances and cross-sections of the outlets 67 and 68 on the other hand, the chip divider groove can only extend up to the vicinity of the outlet as shown for the chip divider groove 12 e.g. in FIGS. 12 to 15 or even run directly into or through the outlet as shown for the chip divider groove 11 and the outlet 67 in FIGS. 12 to 15. Even in an arrangement close to the outlet a significant part of the coolant and/or lubricant already reaches the cutting edge through the chip groove and can develop a cooling or lubricating effect there, in addition to the coolant and/or lubricant already reaching the cutting edge from the outside or via the outer sides.

The extension of the chip divider groove from the drilling edge into the free areas or also into the chip surface can be designed in completely different shapes and lengths.

Thus, as for example in FIGS. 12 to 14, a linear extension can be selected which has the advantage of being easily produced with a grinding wheel, whereby the linear extension can be tangential to a circle around the tool axis A or also oblique to a tangential direction.

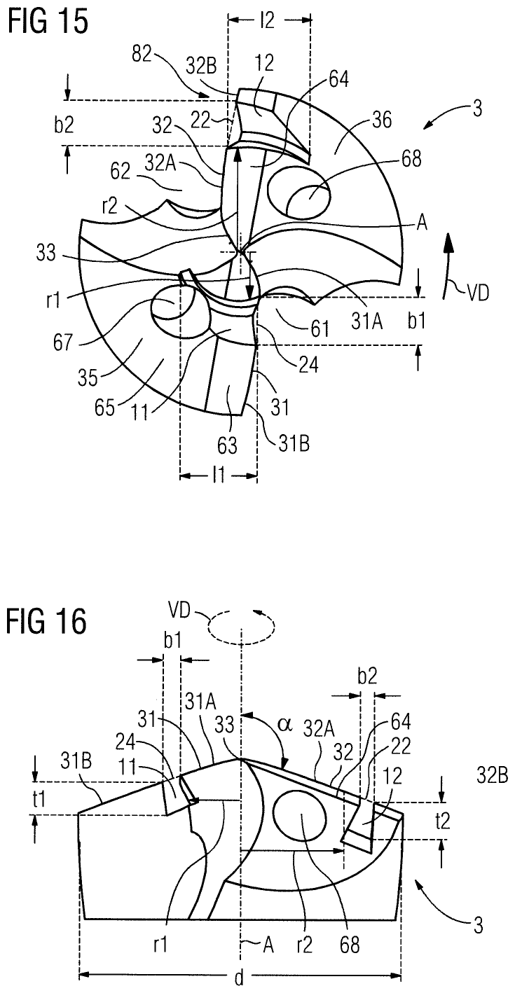

Furthermore, a curved course of the extension of the chip grooves is also possible, as shown for example in FIG. 15. Here, for example, one can choose a course along a circle around the tool axis A or another curved curve.

The length of a curved course is then to be determined as the arc length, although only a tangential length l1 or l2 is drawn in FIG. 15.

In an embodiment not shown, at least one of the chip grooves or each chip groove may extend from the drilling edge into the free area or into the rake face, also in the form of two, three or more linear sections, which are inclined to each other or arranged at an angle to each other. The linear extension of each section of the chip groove(s) can be tangential to a circle around the tool axis A or oblique to a tangential direction. In this way the chip divider groove can be approximated to a course along the circumference or along a curvature, in particular a circular curvature, in particular around the tool axis A, in the manner of a partial polygon. Each linear section can now preferably be generated again by a linear movement of a grinding wheel.

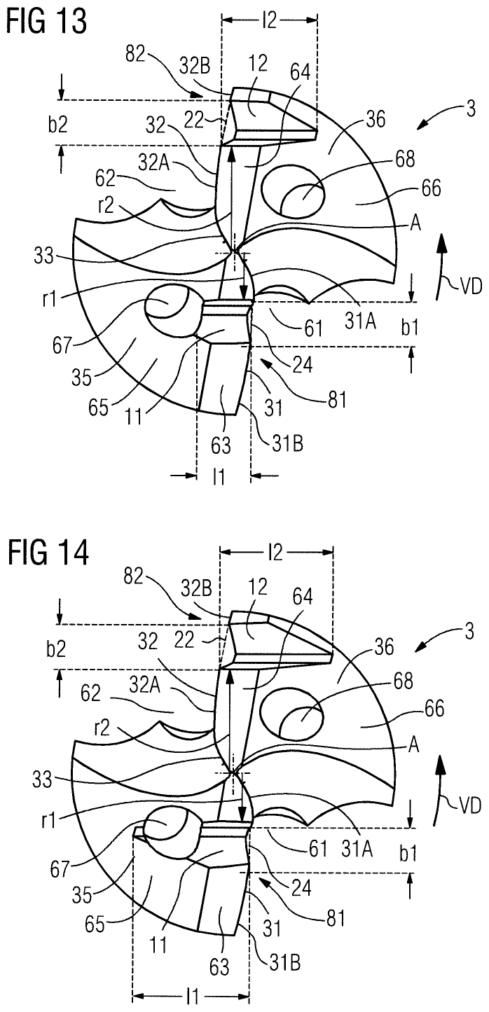

For example, the linear chip divider groove of chip divider 11 shown in FIG. 13 can be extended by another linear chip divider groove inclined inwards towards the tool axis A at an angle to it, which adjoins behind the chip divider groove 11 and can, for example, partially run through outlet 67. The chip divider grooves obtained now form linear sections of a common connected chip divider groove. A further linear chip groove can also be connected to the linear chip groove 12.

In addition, chip grooves with consecutive linear and curved sections can also be provided.

The axial depths t1 and t2 of the chip divider grooves of chip dividers 11 and 12 measured in axial direction to the tool axis A from interruption 21 or 22 can be selected in a wide range and are preferably equal to each other.

In an advantageous embodiment, the axial depths t1 and t2 of the chip divider grooves of the chip dividers 11 and 12 are adjusted within a range of exactly or approximately the axial feed P/2 of the tool between the two drilling edges 31 and 32 and thus the chip thickness, so that the chip can be completely divided or at least weakened sufficiently so that it can then be broken. In general with a number n of drilling edges, the axial depth of the chip divider at the interruption of the drilling edge is essentially in a range of P×0.5/n to P×1.1/n, in particular P×0.8/n to P×1/n, preferably at P/n.

The chip divider grooves or chip dividers 11 and 12 preferably also have a clearance angle, in particular an axial clearance angle and/or a radial clearance angle, preferably from a range of 0° to 20°, in particular 14°, which also affects the axial depth.

The position, shape and length as well as the cross-section of the chip divider grooves can be selected within wide limits depending on the desired chip pitch and other functions and parameters. Thus the chip formation can be influenced in different ways by different tearing and compression and also the wear can be positively influenced.

A preferred embodiment with an almost triangular or narrow trapezoidal cross-section of the chip divider grooves of chip dividers 11 and 12 is shown in FIGS. 11 to 15. These straight chip grooves with such a cross section according to FIG. 11 could be produced with a thread grinding wheel already used when generating the thread generation area, which would be a simplification from the manufacturing point of view.

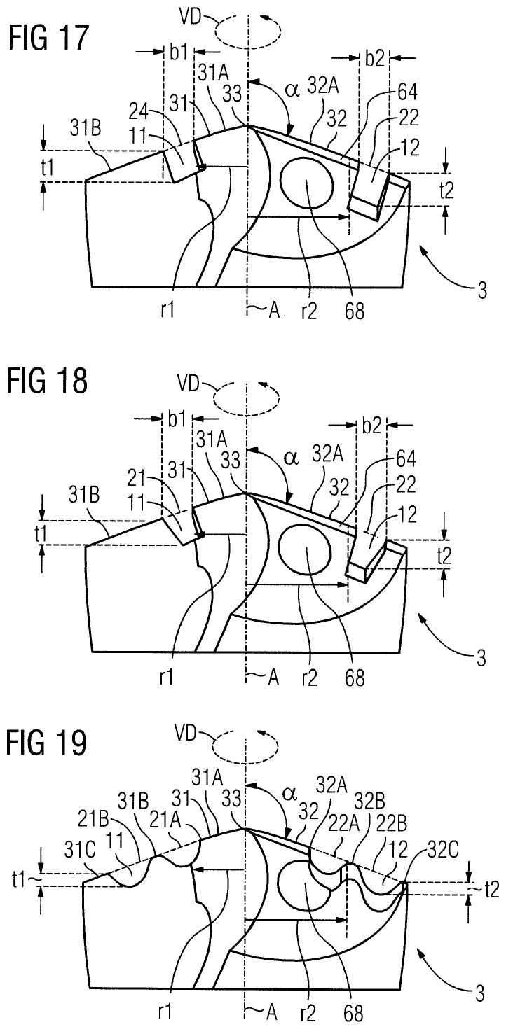

However, a dovetail-shaped cross-section of the chip grooves of chip dividers 11 and 12 in the form of an undercut trapezoid as shown in FIG. 16 is also possible, or a rectangular cross-section of the chip grooves of chip dividers 11 and 12 as shown in FIG. 17, or a trapezoidal cross-section of the chip grooves of chip dividers 11 and 12 with a wider groove base as shown in FIG. 18.

FIG. 19 shows an embodiment of a wave-shaped double groove as chip divider 11 and 12.

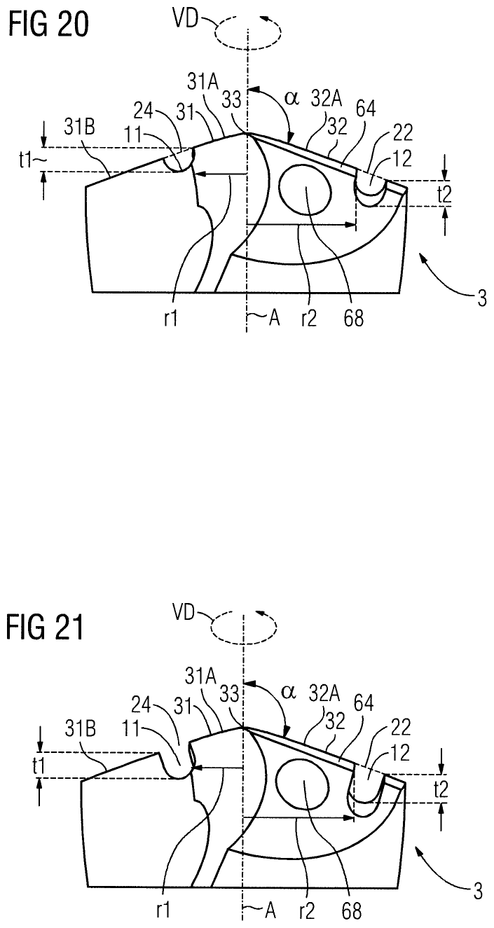

FIG. 20 shows an embodiment with a round, in particular semi-circular, cross-section of the chip divider grooves of chip dividers 11 and 12.

FIG. 21 shows an embodiment form with a cross-section of the chip grooves of chip dividers 11 and 12 which is round in the groove base, in particular semi-circular, and continues linearly and parallel to each other on the groove side walls.

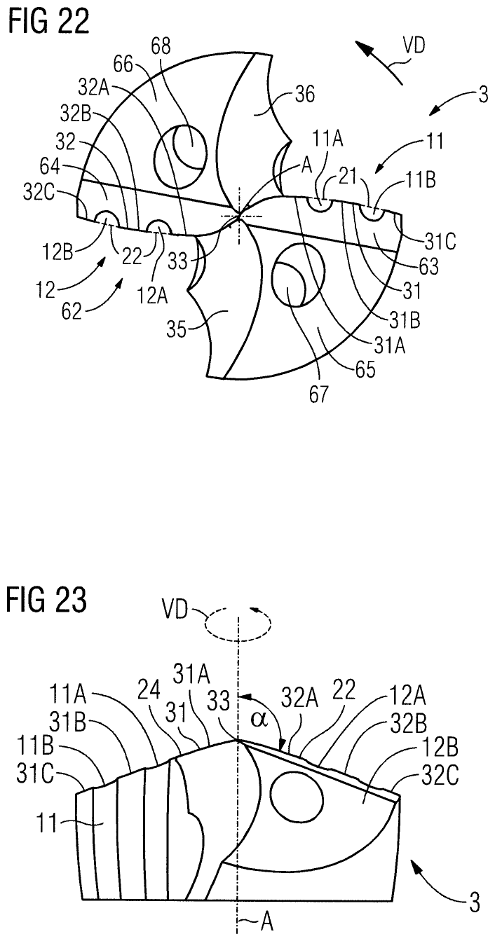

FIGS. 22 and 23 now show an embodiment of drilling area 3, in which the chip dividers 11 and 12 each have two chip divider grooves 11A and 11B or 12A and 12B extending from the chip removal groove 61 or 62 or the rake face 81 or 82 into the drilling edge 31 or 32, by which the drilling edge 31 or 32 is divided into three partial cutting edges 11A, 11B and 11C and 12A, 12B and 12C respectively.

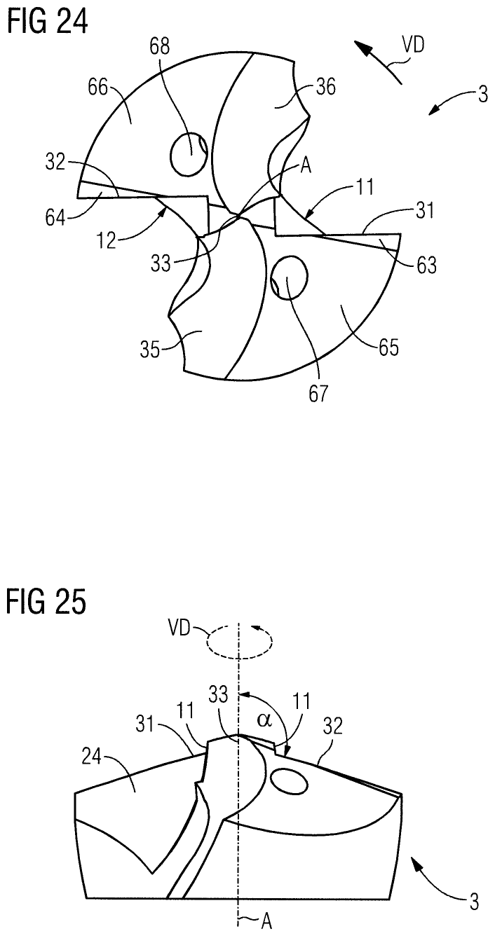

Finally, in the embodiment according to FIGS. 24 and 25, chip divider 11 or 12 comprises a chip divider step instead of a chip divider groove, which can be produced by an approximately 90° face grinding. Here the chip divider step forms the interruption of the drilling edge, which divides it into two partial cutting edges, whereby the drill chip is also divided.

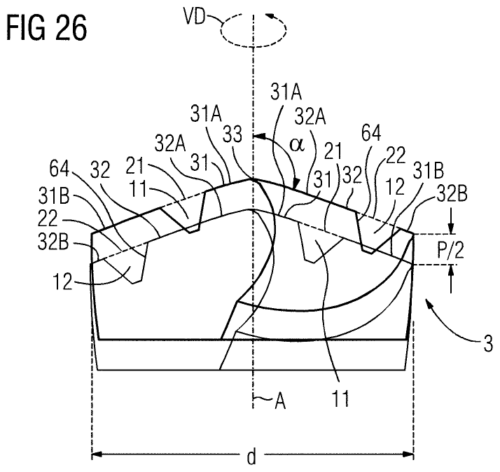

FIG. 26 shows in a superposition the drilling area according to FIG. 11 in two positions rotated 180° against each other and offset by a corresponding axial feed of P/2. One can see the radially offset chip dividers 11 and 12 and that the area recessed by one chip divider is then removed by the following drilling edge. It can also be seen that the chip dividers 11 and 12 can completely cut through the chips due to their axial depth of about P/2. However, if necessary, weakening the chips by a furrow at a lower axial depth of the chip dividers than P/2 would also be sufficient to divide the chips in their radial dimension.

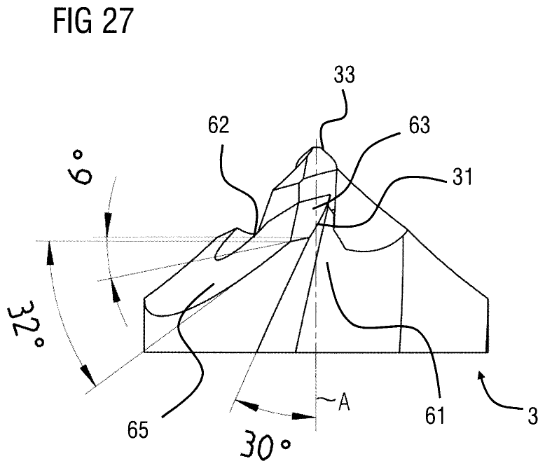

In FIG. 27 a special and advantageous embodiment is shown, in which a first clearance angle of the first free area(s) immediately behind the drilling edge(s) of 6° is selected, whereby only the first free area 63 is visible behind the drilling edge 31, and a second clearance angle of the second free area(s) behind the respective first free area of 32° is selected, whereby only the second free area 65 is visible behind the first free area 63. Furthermore, the preferred angle of twist of the chip removal grooves, drawn at the chip removal groove 61, is 30°.

Continuous drilling edges without chip dividers generate short and curled up drill chips (comma chips) which are well suited for the process. These typically have the length of the circumferential distance or pitch angle between successive drilling edges and curl up at different radii due to different cutting speeds and path lengths. However, tests have shown that these smaller drill chips can become entangled and jammed in the thread turn 50 produced by the thread generation area 4, thereby disrupting or even making the process impossible, so that the desired thread depths of 2 to 2.5 times the diameter D could not be achieved, and tool breakage frequently occurred.

However, the chip dividers according to the invention and the described embodiments now generate additional band chips in drilling area 3, i.e. long continuous and little curled up drill chips, which are actually useless for the process and can lead to tool breakage, at least the desired ones. Thus, an person skilled in the art would not consider chip splitters for this combined tool, because they would even aggravate the chip problem from the expectation and from the experience of the expert, instead of improving it.

The invention is now based on the surprising observation that, nevertheless, the combined tool and process according to the invention practically no band chips are generated or discharged from the chip removal grooves 25. Investigations into why this is so have not yet been completed. From the present point of view, the inventors explain these extremely surprising observations as follows. Due to their size, the band chips produced in the drilling area 3 due to the chip dividers do not settle in thread turn 50. Rather, the band chips moving through the chip removal grooves 25 between the webs 27, in particular the web edges 28, the chip area 7 and the core hole wall provided with the thread turn 50, i.e. not smooth, are strongly deformed and thus broken. The thread turn 50 thus appears to act as a kind of chip divider for the band chips. With a smooth wall, the band chips would not be able to be broken. This results in broken band chips or broken pieces of band chips which become so small that they are harmless for the process. This unexpected effect and surprising but pleasing finding has now led to the fact that the desired thread depths can easily be achieved with the chip dividers.

Drilling area 3 can also have guide areas on its outer wall, which can serve to guide tool 2 in the generated hole and for this purpose are either adjacent to the core hole wall or only slightly spaced from it. Instead of or in addition to the guide areas, circumferential cutting edges or jacket cutting edges can also be provided, which machine or prepare the jacket wall of the core hole by removing material from areas of the workpiece 6 that are radially outwardly adjacent to the tool axis A. These shell cutting edges can be used to achieve a sufficient surface quality also of the shell wall or the inner wall of the core hole and run in particular mainly parallel or slightly inclined backwards (to reduce friction) to the tool axis A at a radial distance d/2 from the tool axis A, which corresponds to half the inner diameter of the core hole. The guide areas or circumferential or jacket cutting edges can be designed and/or arranged directly adjacent to the frontal drilling edges or can be slightly offset axially from these.

In particular, a cylindrical guide area can be arranged on the radially outwardly projecting outer surfaces of the drill webs 35 and 36, at least in the area of the first free areas 63 and 64. This serves to stabilise the axially comparatively short drilling area 3.

In an embodiment not shown, the drill tip 33 can also be designed as a centring tip.

### LIST OF REFERENCE SIGNS

2 Tool
3 Drilling area
4 Thread generation area
5 Threaded hole
6 Workpiece
7 Chip area
11, 12 Chip divider
11A, 11B Chip groove
12A, 12B Chip groove
20 Working area
21, 22 Interruption
24 Shank
25 Chip removal groove
27 Web
28 Web edge
31, 32 Drilling edges
31A, 31B Drill part cutting edge
31C Drill part cutting edge
32A, 32B Drill part cutting edge
32C Drill part cutting edge
33 Drill tip
41, 42 Thread tooth
50 Thread turn
51 Circumferential groove
53 Drill hole
60 Workpiece surface
61, 62 Chip removal groove
63, 64 Free area
65, 66 Free area
67, 68 Outlet
81, 82 Rake face
A Tool axis
b1, b2 Width (of the chip divider)
d Core hole diameter
D Threaded hole diameter
l1, l2 Length (of the chip divider)
M Thread centre axis
P Thread pitch
RB Backward movement
RD Reverse direction of rotation
T Penetration depth
T_{G} Thread depth
T_{L} Threaded hole depth
t1, t2 Depth (of the chip divider)
VB Forward movement
VD Forward direction of rotation
α Angle of inclination

1-21. (canceled)

22. A tool for generating a threaded hole, wherein:
a) the tool is rotatable in a working movement in a rotational movement with a predetermined direction of rotation about a tool axis (A) extending through the tool and at the same time is movable in an axial forward direction axially of the tool axis,
b) said tool comprises at least one thread generation area and at least one drilling area which are rigidly motion-coupled to each other,
c) the drilling area is provided for generating a core hole and is arranged axially offset to the tool axis with respect to the thread generation area and/or is arranged in an area of the tool lying further forward in the forward direction, in particular at a front or free end, than the thread generation area,
d) the thread generation area projects radially to the tool axis further outwards than the drilling area,
e) the thread generation area runs along a helical line or thread helix with a predetermined thread pitch angle and a predetermined winding sense of the thread to be generated and has a working profile which corresponds to the thread profile of the thread to be generated,
f) the drilling area has at least one drilling edge, and
g) at least one chip divider is arranged on the drilling edge, which forms an interruption of the drilling edge.

23. The tool according to claim 22, wherein:
the drilling area has a number n of at least two drilling edges which are arranged offset to one another in the direction of rotation, in particular by a pitch angle of 360°/n;
at least one chip divider is arranged on each of the n drilling edges; and/or
the radial diameter of the drilling area relative to the tool axis is at most 10 mm.

24. The tool according to claim 22, wherein:
the radial distances of the chip dividers from the tool axis are different at different drilling edges in such a way that in a rotational projection or in the direction of rotation around the tool axis, an interruption formed by a chip divider at a first drilling edge is followed by a cutting area or a drill part cutting edge of a second drilling edge.

25. The tool according to claim 22, wherein the axial depth of the chip divider measured in the axial direction to the tool axis from the interruption of the cutting edge lies essentially in a range of 0.5/n to 1.1/n times, in particular 1/n times, the thread pitch of the thread generation area.

26. The tool according to claim 22, wherein:
a radial width (b1, b2) of a chip divider interruption ranges from 0.05 times to 0.25 times the diameter (d) of the drilling area; and/or
the rake face at each drilling edge is not provided with a chip forming surface or chip forming step.

27. The tool according to claim 22, wherein at least one chip divider is designed as a chip divider groove, which forms an interruption at the respective drilling edge.

28. The tool according to claim 27, wherein:
at least one chip divider groove of the respective chip divider extends from the respective drilling edge, in particular into an adjacent free area or sequence of free areas, in particular with a substantially linear course or a sequence of at least two or three inclined to each other, in particular linear sections inclined inwards towards the tool axis, the linear extension of the chip groove or its sections running in particular in each case tangentially to a circle around the tool axis, or also with a course which is curved at least in sections, preferably convexly curved towards the tool axis

29. The tool according to claim 22, wherein at least one chip divider or chip divider groove has a cross-section in the shape of a triangle or trapezoid or dovetail or rectangle or double wave or rounding, in particular a semicircle, possibly with extended linear side walls.

30. The tool according to claim 22, wherein at least one chip divider is designed as a chip divider step or is designed as a chip divider groove extending on the rake face of the respective drilling edge

31. The tool according to claim 22, wherein:
each drilling edge is arranged and/or formed on an associated drill web;
at least one first free area, which adjoins the drilling edge, is formed on each drill web, in particular on an end face of the drill web;
in particular the clearance angle of the first free areas in a radially outer area is selected between 3° to 15° or between 5° to 15°, in particular 6° or 10°, and preferably increases radially inwards, in particular up to a maximum of 40°; and/or
the first free area is in particular cone-shaped or even.

32. The tool according to claim 31, wherein:
at least one second free are, which adjoins the rear side of the first free area remote from the drilling edge, is formed on each drill web, in particular on an end face of the drill web;
the second free area is more strongly exposed or is arranged at a larger clearance angle than the first free area;
the clearance angle of the second free areas is selected in a radially outer area preferably in a range between 15° and 40° or between 20° and 40°, in particular 32°, and/or
the second free areas are curved or flat.

33. The tool according to claim 22, wherein:
at least one chip divider groove of the respective chip divider extends from the respective drilling edge into the first free area(s) lying behind it and usually also into the second free area, a length (l1, l2) of the extension of the chip divider groove being adjustable in particular by the clearance angle of the first and/or second free area.

34. The tool according to claim 22, wherein at least one or the chip groove extends to an outlet for coolant and/or lubricant in the associated drill web.

35. The tool according to claim 22, comprising:
at least one and preferably at least two chip removal grooves, which start in the drilling area and continue through the thread generation area into a chip area which, viewed axially to the tool axis (A), directly adjoins the thread generation area on the side opposite the drilling area, webs being arranged and formed between the chip removal grooves at least in the chip area.

36. The tool according to claim 35, wherein:
the chip removal grooves and the webs between them run twisted around the tool axis, in particular at a constant or variable twist angle, typically in an interval of 0° to 50°, in particular 20° to 35°, for example 30°; and/or
on the webs in the front area, there is firstly one drilling web of the drilling area and then the thread tooth or teeth of the thread generation area.

37. The tool according to claim 35, wherein:
the axial length of the chip removal grooves is greater than the maximum hole depth or penetration depth Tₘₐₓ of the tool, so that the chip removal grooves always extend into an area above or outside the workpiece surface and can evacuate the chips from the threaded hole.

38. The tool according 35, wherein:
web edges are formed at the outer transition areas between the webs and the chip removal grooves, at least in the chip removal area directly adjoining the thread generation area, which web edges are generally blunt or non-cutting and in particular follow the course of the chip removal grooves; and/or
the radial diameter (d′) of the webs and thus of the web edges in the chip area is equal to or slightly smaller than the diameter (d) of the drilling area and thus of the core hole wall produced, in particular between 90% and 100%, for example 99.8%, of this diameter.

39. A method for generating a thread with a predetermined thread pitch and with a predetermined thread profile in a workpiece, comprising:
a) using a tool for generating a threaded hole, wherein: (i) the tool is rotatable in a working movement in a rotational movement with a predetermined direction of rotation about a tool axis (A) extending through the tool and at the same time is movable in an axial forward direction axially of the tool axis, (ii) said tool comprises at least one thread generation area and at least one drilling area which are rigidly motion-coupled to each other, (iii) the drilling area is provided for generating a core hole and is arranged axially offset to the tool axis with respect to the thread generation area and/or is arranged in an area of the tool lying further forward in the forward direction, in particular at a front or free end, than the thread generation area, (iv) the thread generation area projects radially to the tool axis further outwards than the drilling area, (v) the thread generation area runs along a helical line or thread helix with a predetermined thread pitch angle and a predetermined winding sense of the thread to be generated and has a working profile which corresponds to the thread profile of the thread to be generated, (vi) the drilling area has at least one drilling edge, and (vii) at least one chip divider is arranged on the drilling edge, which forms an interruption of the drilling edge;
wherein:
b) the tool is moved into the workpiece in one working movement during first work phase,
c) the working movement comprises a rotational movement with a predetermined direction of rotation about the tool axis of the tool and an axial feed movement of the tool in an axial forward direction axially of the tool axis, synchronised with the rotational movement according to the thread pitch of the thread generation area, such that a full rotation of the tool about the tool axis corresponds to an axial feed of the tool by the predetermined thread pitch,
d) during the working movement, the drilling area of the tool generates a core hole in the workpiece and the thread generation area generates phase a thread in the inner wall of the core hole produced by the drilling area in the first working, the thread running under the predetermined thread pitch, the drilling area and the thread generation area executing the working movement together without changing their relative position to each other.

40. The method according to claim 39, wherein:
a) in a deceleration movement following the working movement, the tool is moved further into the workpiece in the same forward direction as the working movement to a reversal point during a second working phase; and
b) after reaching the reversal point, a reversing movement of the tool is initiated, with which the tool is moved out of the workpiece,
wherein:
c) the reversing movement comprises firstly a first reversing phase, during which the thread generation area of the tool is guided back into the thread of the generated thread, and then a second reversing phase, during which the thread generation area is guided out of the workpiece through the thread.

41. The method according to claim 39, wherein:
a) the axial feed of the tool in relation to a full revolution, at least during part of the deceleration movement, is smaller than the thread pitch and is zero at the reversal point; and
b) the thread generation area generates at least one, in particular closed or annular, circular or circumferential groove in the workpiece during the deceleration movement.

42. The method according to claim 39, wherein:
a) the tool further comprises at least one and preferably at least two chip removal grooves, which start in the drilling area and continue through the thread generation area into a chip area which, viewed axially to the tool axis, directly adjoins the thread generation area on the side opposite the drilling area, webs (being arranged and formed between the chip removal grooves at least in the chip area;
b) band chips produced in the drilling area due to the chip dividers are guided through the chip removal grooves, in particular are not already broken in the drilling area, and are broken between the webs, in particular the web edges, of the chip area on the one hand and the threaded hole wall provided with the thread produced by the thread generation area on the other hand; and
c) the broken pieces of the band chips are guided through the chip removal grooves to the outside of the threaded hole.
